(19) United States
(12) Patent Application Publication
(10) Pub. No.: US 2025/0005820 A1
(43) Pub. Date: Jan. 2, 2025

(54) JOINT IMAGE GENERATING DEVICE, JOINT IMAGE GENERATING METHOD, AND JOINT IMAGE GENERATING PROGRAM

(71) Applicant: pixiv Inc., Tokyo (JP)

(72) Inventors: Kazumasa Kawazure, Tokyo (JP); Kazuma Kuori, Tokyo (JP); Tsubasa Ohno, Tokyo (JP)

(73) Assignee: pixiv Inc., Tokyo (JP)

(21) Appl. No.: 18/883,596

(22) Filed: Sep. 12, 2024

Related U.S. Application Data
(63) Continuation of application No. PCT/JP2023/007519, filed on Mar. 1, 2023.

(30) Foreign Application Priority Data
Mar. 15, 2022 (JP) 2022-040675

(51) Int. Cl. G06T 11/20; G06T 5/50; G06T 11/60

(52) U.S. Cl. CPC G06T 11/203; G06T 5/50; G06T 11/60; G06T 2207/20221

(57) ABSTRACT

A joint image generating device includes: an output unit that outputs information on a canvas that accepts drawing from a user; a receiver that accepts drawing on the canvas from each of a plurality of users; a generator that generates an image by reflecting the drawing from each of the users on the canvas; and a storage that associates and stores an image drawn on the canvas with user identification information that indicates the user that has performed drawing on the image. The output unit outputs the image generated by the generator.

### CROSS-REFERENCE TO RELATED APPLICATIONS

This application is a continuation application of International Application No. PCT/JP2023/007519, filed on Mar. 1, 2023, which claims priority of Japanese (JP) Patent Application No. 2022-040675, filed on Mar. 15, 2022, the contents of each of which are hereby incorporated by reference in its entirety.

### TECHNICAL FIELD

This disclosure relates to a joint image generating device for jointly creating an image by a plurality of users, and a joint image generating method and joint image generating program for the same.

### BACKGROUND

Systems have been present to disclose and evaluate various types of contents online in recent years. Japanese Laid-Open Patent Publication No. 2011-507110 discloses a system for sharing a content in a public system and allowing anyone to evaluate the content.

### SUMMARY

A system for joint creation of computer graphics by multiple users as a form of online content has been desired to be emerged.

An object of this disclosure, therefore, is to provide a joint image generating device, a joint image generating method, and a joint image generating program that enable multiple users to jointly create an image.

To solve the above problem, a joint image generating device according to an embodiment of this disclosure includes: an output unit that outputs information on a canvas that accepts drawing from a user; a receiver that accepts drawing on the canvas from each of a plurality of users; a generator that generates an image by reflecting the drawing from each of the users on the canvas; and a storage that associates and stores an image drawn on the canvas with user identification information that indicates the user that has performed drawing on the image. The output unit outputs the image generated by the generator.

To solve the above problem, a joint image generating method according to an embodiment of this disclosure causes a computer to execute the steps of: outputting information on a canvas that accepts drawing from a user; accepting drawing on the canvas from each of a plurality of users; generating an image by reflecting the drawing from each of the users on the canvas; and associating and storing an image drawn on the canvas with user identification information that indicates the user that has performed drawing on the image. The outputting step outputs the image generated in the generating step.

To solve the above problem, a joint image generating program according to an embodiment of this disclosure causes a computer to embody the functions of: outputting information on a canvas that accepts drawing from a user; accepting drawing on the canvas from each of a plurality of users; generating an image by reflecting the drawing from each of the users on the canvas; and associating and storing an image drawn on the canvas with user identification information that indicates the user that has performed drawing on the image. The outputting function outputs the image generated by the generating function.

In the joint image generating device above, the receiver may accept drawing on a layer as a canvas that can be drawn by each user for each of the users, the storage may store a layer identifier that identifies the layer on which corresponding users have performed drawing, and the generator may superimpose the layer of each of the users to reflect the drawing from each of the users on the canvas to create the image.

The joint image generating device above may further include: a first request receiver that accepts an edit request from a first user of the users for an image input by a second user other than the first user; a first transmitter that transmits the edit request from the first user to the second user; a receiver that receives permission/rejection information indicating permission/rejection of editing by the first user from the second user; and an editing unit that accepts drawing by the first user on the image that has been drawn by the second user and edits the image that has been drawn by the second user if the permission/rejection information indicates permission.

In the joint image generating device above, the editing unit may accept drawing from the first user and edit the layer indicated by the layer identifier associated with the second user on the basis of the accepted drawing from the first user.

The joint image generating device above may further include: a second transmitter that transmits to the first user rejection information indicating that drawing cannot be performed by the first user on the image that has been drawn by the second user when the permission/rejection information indicates rejection.

The joint image generating device above may further include: a specifier that accepts from each of the users specification of a layer to be drawn by the user. The storage may associate and store a layer identifier indicated by the specification of the layer from the user accepted by the specifier with a user identifier of the user that has specified the layer.

The joint image generating device above may further include: a second request receiver that accepts a request from a third user of the users to output the image drawn by the third user for the image drawn on the canvas; and a third transmitter that transmits to the third user an image of a portion drawn by the third user and certification information that certifies that the image has been drawn by the third user when the output request is accepted.

According to this disclosure, the joint image generating device is capable of accepting drawing from each of the terminal devices of multiple users and providing each of the terminal devices with a joint image into which those drawings are integrated, thus providing a system for joint drawing by multiple users. The image is drawn in real time, and users criticize and correct the image with each other as they are drawing at any given time, and thus creation of better computer graphics is expected.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 shows a system diagram illustrating an example of a configuration of a joint image generating system,

FIG. 2 shows a block diagram illustrating an example of a configuration of a server,

FIG. 3 shows a block diagram illustrating an example of a configuration of a terminal device,

FIG. 4 shows a conceptual data diagram illustrating an example of a data structure of joint image information,

FIG. 5 shows a first sequence diagram illustrating an example of exchanges among devices related to creation of a joint image in the joint image generating system,

FIG. 6 shows a flowchart illustrating an example of an operation of the terminal device for the first sequence diagram,

FIG. 7 shows a flowchart illustrating an example of an operation of the server for the first sequence diagram,

FIG. 8 shows a second sequence diagram illustrating an example of exchanges among devices related to modification of drawings of other users during the creation of the joint image in the joint image generating system,

FIG. 9 shows a flowchart illustrating an example of an operation of the terminal device for the second sequence diagram,

FIG. 10 shows a flowchart illustrating an example of an operation of the terminal device for the second sequence diagram,

FIG. 11 shows a flowchart illustrating an example of an operation of the server for the second sequence diagram,

FIG. 12 shows a third sequence diagram illustrating an example of exchanges between devices related to issuance of certification information in the joint image generating system,

FIG. 13 shows a flowchart illustrating an example of an operation of the terminal device for the third sequence diagram,

FIG. 14 shows a flowchart illustrating an example of an operation of the server for the third sequence diagram,

FIG. 15A shows a diagram illustrating an example of an image composition of the joint image,

FIG. 15B shows a diagram illustrating an example of the joint image, and

FIG. 15C shows a diagram illustrating an example of certification information.

### REFERENCE SIGNS LIST

100: Server (Joint Image Generating Device)
110: Communication Unit
120: Input Unit
130: Controller
131: Receiver
132: Generator
133: Editing Unit
134: Issuance Unit
140: Storage
150: Output Unit
200, 200a, 200b, 200c: Terminal Device
210: Communication Unit
220: Input Unit
230: Controller
240: Storage
250: Output Unit
300: Network

### DETAILED DESCRIPTION

A joint image generating device according to this disclosure will be described below with reference to the drawings.

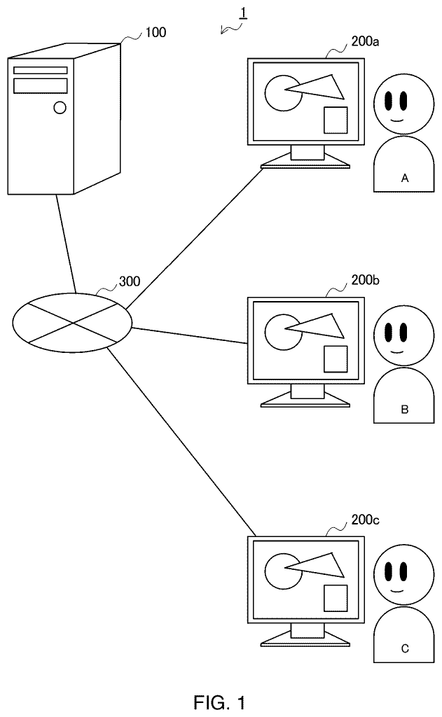

FIG. 1 shows a system diagram illustrating an example of a configuration of a joint image generating system. As shown in FIG. 1, a joint image generating system 1 includes terminal device 200a to 200c used by users A to C that jointly draw an image on a single canvas, and a server (information processing device) 100 connected to the terminal devices 200a to 200c via network 300. The terminal devices 200a to 200c correspond to information processing devices held by the corresponding users and are embodied by PCs, notebook PCs, tablet terminals, and smartphones, for example, but are not limited to these devices. The server 100 corresponds to a server device with functions of accepting access (drawing) from each of the terminal devices 200a to 200c and providing each of the terminal devices 200a to 200c with a joint image, which server device may serve as a joint image generating device. The joint image corresponds to an image drawn by multiple users on a single canvas.

The joint image generating system 1 shown in FIG. 1 corresponds to a system for joint drawing by multiple users drawing on a single canvas. Each user performs drawing on the canvas provided by the server 100 via her/his terminal. Each of the terminal devices 200a to 200c transmits information to the server 100 indicating what the corresponding user has drawn. The server 100 then provides each of the terminal devices 200a to 200c with a joint image that is a composite of the contents drawn from each of the terminal devices. Accordingly, the image displayed on each of the terminal devices 200a to 200c shall be a common image. As described above, the joint image generating system 1 allows multiple users to create a single image or consult with each other by drawing on a single canvas on the spot. The joint image generating system 1 will be described in detail below.

### Configuration

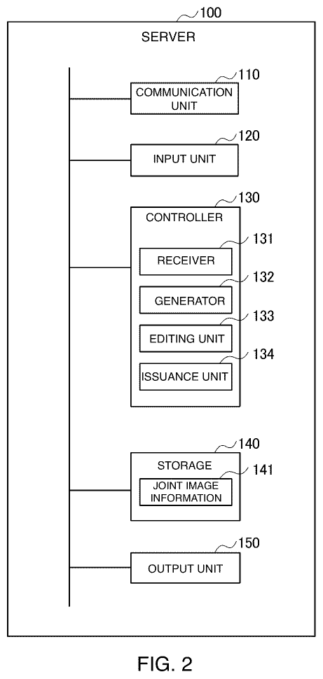

FIG. 2 shows a block diagram illustrating an example of a configuration of the server 100. The server 100 corresponds to a computer system including a processor and memory, as well as an image processing device that processes images, and also a web server that accepts access from each of the terminal devices and provides a joint image. The server 100 is embodied as a server device as described above, but may also be embodied by a PC, notebook PC, and tablet terminal, for example.

As shown in FIG. 2, the server 100 includes a communication unit 110, an input unit 120, a controller 130, a storage 140, and an output unit 150.

The communication unit 110 corresponds to a communication interface that communicates and exchanges information with other information processing devices outside the server 100. Specifically, the communication unit 110 executes communication with the terminal devices 200 (200a to 200c) via the network 300. The communication unit 110 receives information from other external information processing devices, for example, and transmits the received information to the controller 130. The communication unit 110 also transmits information to other external information processing devices according to instructions from the controller 130. The communication unit 110, as an example, communicates the content of the drawing performed by the user of the terminal device 200 from the terminal device 200 to the controller 130. The information indicating the drawing content that the communication unit 110 receives from the terminal device 200 may include information such as the drawing position on the canvas (coordinates on the canvas), the tool used for drawing (pen, eraser, brush type and thickness of the drawing, for example), and the color of the drawing. The information may include any other information if it is related to the drawing. The information may include only some of the pieces of the information listed above. The communication unit 110 transmits the joint image or information on the joint image communicated by the controller 130 to the terminal device 200. The information on the joint image refers to information needed for displaying the joint image on the terminal device 200. For example, it may be any information that instructs each terminal device 200 to draw the joint image on the basis of the content of the drawing that has been received from one terminal device 200. It may be instructional information that instructs drawing on the basis of the content of drawing.

The input unit 120 accepts input from the operator of the server 100 to the server 100 and communicates the accepted input to the controller 130. The input unit 120 may be embodied by a mouse, touch pad, and keyboard as an example, but is not limited to these.

The controller 130 is directed to a processor that controls various portions of the server 100. The controller 130 executes various programs using various data stored in the storage 140 to embody the functions to be embodied by the server 100.

The controller 130 serves as a receiver 131, a generator 132, an editing unit 133, and an issuance unit 134. The controller 130 accesses the server 100 and provides each of the terminal devices 200 of the users registered as a group of generating an image simultaneously with a canvas for the users to perform drawing. This canvas corresponds to a base sheet on which the users draw an image. The canvas is configured by layers each assigned by the controller 130 to a corresponding one of the users in the present embodiment. Each user of the terminal device 200 substantially draws an image on the layer assigned to herself/himself, and superimposes the images of their respective layers to create a composite joint image so that the controller 130 transmits the joint image represented on the canvas after the composition to each terminal device 200 for display. This allows each user to feel as if she/he is cooperating with the other users to jointly create an image. That is, the canvas corresponds to a sheet for displaying the joint image generated by the layer composition.

In the layer composition, priority is basically given to the drawing located on the top (front) side. That is, the user located at the top (front) has a higher priority to some extent. Accordingly, to eliminate unfairness, the order of the layer composition may be randomly determined by the server 100, but is not limited to only the random determination by the server 100. The server 100 may synthesize the images in a predetermined order, for example, in the order in which the users have participated in the creation of the joint image rather than random order, or the users that create the joint image may consult the other users to allow the server 100 to synthesize the images in an order in accordance with settings on the basis of the results of the consultation. The controller 130 may include a setting unit for setting the order of the layer composition although the setting unit is not shown in FIG. 2.

The receiver 131 accepts drawing to the canvas (substantially a layer assigned to each user (terminal device 200)) of the user of each terminal device 200 communicated via the communication unit 110. The receiver 131 communicates the accepted drawing content to the generator 132. As described above, the drawing content may include pieces of information such as the position of the drawing on the canvas (coordinates on the canvas), the tool used for drawing (pen, eraser, type of brush, and thickness of the drawing, for example), and the color of the drawing. The information may include other information or only some of the pieces of the information listed above. The receiver 131 also communicates to the generator 132 from which user the drawing content is accepted.

The generator 132 generates an image by reflecting the drawing from the user of each terminal device 200 on the canvas in accordance with the drawing content communicated by the receiver 131. That is, the generator 132 reflects the communicated drawing content on the layer corresponding to the communicated user. The reflected (updated) layer is then combined with the current layer of the other users to generate a joint image. The generator 132 transmits the generated joint image to the terminal devices 200 of all the associated users via the communication unit 110.

When the editing unit 133 receives an edit request from the terminal device 200 of one user that is creating the same joint image (hereinafter, referred to as “user A”) for the drawing content drawn by another user (hereinafter, referred to as “user B”), the editing unit 133 transmits from the user A to the user B, i.e., the terminal device 200b via the communication unit 110 a fact that the editing unit 133 has received the request for editing of the drawing by the user A. When the editing unit 133 receives an acknowledgement of editing by the user A from the terminal device 200 of the user B via the communication unit 110, it temporarily associates the layer that has been associated with the user B with the user A and dissolves the association with the user B. This allows the user A to perform drawing on the layer that has been originally drawn by the user B. That is, the user A can edit the layer. The generator 132 updates the content edited by the user A as drawing content and each terminal device 200 displays it as a joint image. When the editing unit 133 accepts the termination of editing from the user A, it may return the layer associated with the user A to the layer originally associated with the user A, and re-associate the edited layer with the user B again.

The issuance unit 134 issues, on the basis of a request from the user, certification information to certify that the user has indeed drawn the content that the user has drawn in the joint image. Even if the image corresponds to a joint image by multiple users, the portion of the image drawn by each of the users can be said to be copyrighted by the user. In the case of a joint image, the border of copyright may become blurred, and later, when a user wishes to use the content that she or he has drawn on the joint image in another situation, she or he may need evidence to prove that the copyright is indeed held. The issuance unit 134 issues certification information for this purpose. Accordingly, the certification information includes, of a portion of the joint image, information indicating the user that has requested the certification information, the image drawn by that user, date and time information indicating when the image has been drawn, and information indicating that the image has been indeed drawn by the user. The certification information may be issued in paper form or as electronic data. Non-Fungible Token (NFT) using blockchain technology may also be used.

When a request for issuing the certificate information that has been received from the terminal device 200 of the user is transmitted from the communication unit 110 to the issuance unit 134, the issuance unit 134 extracts, as information contained in the issuance request, the user ID of the user that has performed the issuance request, the joint image ID of the joint image indicating for which joint image the issuance request for the certification information is, date and time information indicating when the joint image has been created, and the IDs of other users that have created the joint image. From among these pieces of the information, two of the pieces of information are needed, i.e., the user ID and either the joint image ID or the date and time information as information that can identify the joint image. The other information is not needed, but if it is present, it will facilitate identifying for which image the user desires the certification information.

The issuance unit 134 determines whether the joint image information 141 contains the data that matches the information contained in the communicated issuance request. If the information corresponding to the issuance request has been registered in the joint image information 141, the issuance unit 134 identifies the layer corresponding to the user ID included in the issuance request, and issues certification information including an image of the identified layer, the user ID or the name of the user indicated by the user ID, date and time information indicating when the image has been drawn, and a sentence certifying that the image has been indeed drawn by the user. The issuance unit 134 transmits the issued certification information to the user (terminal device 200) that has performed the issuance request via the communication unit 110. If the corresponding information is not found in the joint image information 141, the issuance unit 134 transmits information indicating that the certification information cannot be issued to the terminal device 200 that has performed the issuance request.

The storage 140 serves to store programs and various data needed by the server 100 to operate. The storage 140 may be embodied by a storage medium such as an HDD, SSD, and flash memory, for example. The storage 140 stores the joint image information 141. The joint image information 141 will be described in detail below.

The output unit 150 serves to output the information specified by the controller 130. The output unit 150, for example, outputs the joint image generated by the generator 132. The output by the output unit 150 may correspond to an image output to a monitor connected to the server 100 or a transmission output to each terminal device 200 via the communication unit 110. An example of the configuration of the server 100 is as described above.

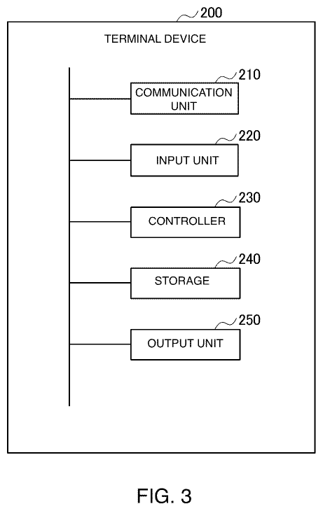

FIG. 3 shows a block diagram illustrating an example of a configuration of the terminal device 200. As described above, the terminal devices 200a to 200c correspond to general PCs, i.e., computer systems each configured by a processor and memory, and since the basic configurations are the same with each other, they are described here as the terminal device 200.

As shown in FIG. 3, the terminal device 200 includes a communication unit 210, input unit 220, controller 230, storage 240, and output unit 250.

The communication unit 210 corresponds to a communication interface that communicates and exchanges information with other information processing devices outside the terminal device 200. Specifically, the communication unit 210 executes communication with the server 100 via the network 300. The communication unit 210 transmits information indicating the content that has been drawn by the user in accordance with the instructions from the controller 230. The information indicating the drawing content that the communication unit 210 transmits may include information such as the drawing position on the canvas (coordinates on the canvas), the tool used for drawing (pen, eraser, brush type and thickness of the drawing, for example), and the color of the drawing. The information may include any other information if it is related to the drawing. The information may include only some of the pieces of the information listed above. Further, the communication unit 210 transmits an edit request to the server 100 for editing drawings of other users in accordance with instructions from the controller 230. Moreover, the communication unit 210 transmits a request for issuing certification information to the server 100 in accordance with instructions from the controller 230. Furthermore, the communication unit 210 receives a joint image or information on the joint image from the server 100 and communicates it to the controller 230.

The input unit 220 accepts input from the user of the terminal device 200 and communicates it to the controller 230. The input unit 220 may be embodied by a mouse, touch pad, and keyboard as an example, but is not limited to these. The input unit 220 accepts input (drawing content) from the user on the canvas and communicates it to the controller 230.

The controller 230 is directed to a processor that controls various portions of the terminal device 200. The controller 230 executes various programs using various data stored in the storage 240 to embody the functions to be embodied by the terminal device 200.

The controller 230 embodies the creation of a joint image by multiple users by executing an application program for generating a joint image, which program is provided via the server 100. The application program may correspond to a native application embodied in the terminal device 200 in cooperation with the server 100, or it may be a browser application provided by the server 100.

When the controller 230 receives drawing from the user via the input unit 220, it transmits drawing information, which corresponds to information indicating the content of the drawing, to the server 100 via the communication unit 210. This drawing information may include information such as the drawing position on the canvas (coordinates on the canvas), the tool used for drawing (pen, eraser, brush type and thickness of the drawing, for example), and the color of the drawing. The information may include any other information if it is related to the drawing. The information may include only some of the pieces of the information listed above.

The controller 230 accepts the joint image or information on the joint image from the server 100 via the communication unit 210, generates the joint image, and causes the output unit 250 to output the image. If what the controller 230 accepts corresponds to the information on the joint image, the controller 230 adds the drawing content indicated by the information to the joint image that has been displayed so far at the location indicated by the information, and causes the output unit 250 to output the joint image after the addition.

The storage 240 serves to store programs and various data needed by the terminal device 200 to operate. The storage 240 may be embodied by a storage medium such as an HDD, SSD, and flash memory, for example.

The output unit 250 serves to output the information specified by the controller 230. The output unit 250, for example, outputs the joint image generated by the controller 230 or the joint image communicated from the server 100. The output by the output unit 250 may correspond to an image output to a monitor connected to the terminal device 200 or a transmission output to an external device via the communication unit 210.

The configuration of the terminal device 200 is as described above.

### Data

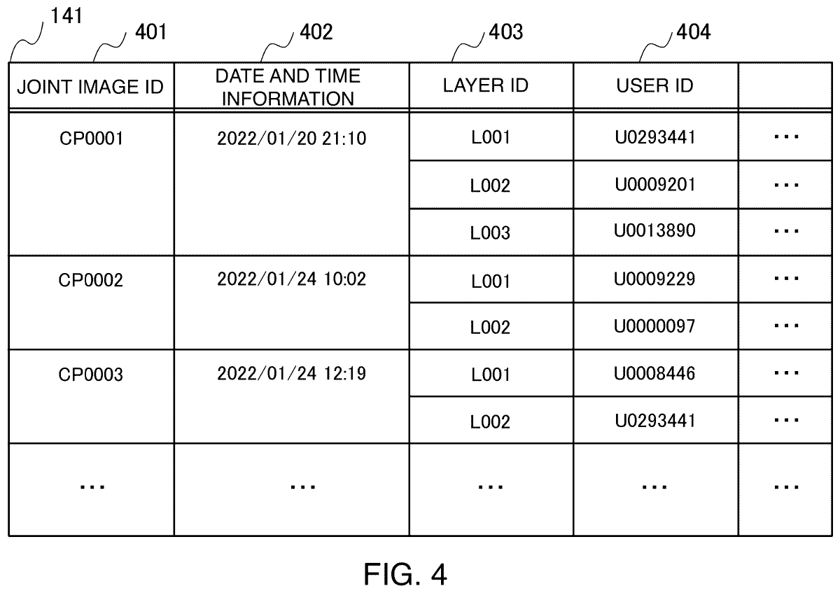

FIG. 4 shows a data conceptual diagram illustrating an example of a structure of the joint image information 141 stored in the storage 140 of the server 100.

The joint image information 141 corresponds to information that specifies, for the joint image drawn by multiple users, which portion of the joint image has been drawn, and by who and when the portion of the joint image has been drawn via the server 100. As shown in FIG. 4, as an example, the joint image information 141 is directed to information in which the joint image ID 401, date and time information 402, layer ID 403, and user ID 404 are associated with each other.

The joint image ID 401 corresponds to unique identification information that allows the server 100 and terminal device 200 to uniquely identify a joint image created by multiple users on the joint image generating system 1. The joint image ID is assigned a unique value for each joint image by the controller 130 of the server 100 each time the creation of a joint image by multiple users is initiated.

The date and time information 402 corresponds to information indicating the date and time when the joint image indicated by the corresponding joint image ID 401 has been created. This date and time information 402 may be directed to the date and time when the creation of the joint image has been started or completed. Alternatively, it may indicate a time period from the start time of the creation to the end time of the creation.

The layer ID 403 corresponds to identification information for uniquely identifying the layer that configures the joint image indicated by the corresponding joint image ID 401. The layer ID may be a unique value within the corresponding joint image. The layer ID 403 is assigned by the controller 130 of the server 100 when a layer is created for each user that creates a joint image. When a user that creates a joint image requests the assignment of a new layer ID, a layer ID for a new layer is assigned.

The user ID 404 corresponds to identification information that uniquely indicates the user associated with the layer indicated by the layer ID 403 in the corresponding joint image 401.

According to the joint image information 141 shown in FIG. 4, the joint image with the joint image ID 401, “CP0001,” has been created on 2022/01/20 21:10.” It can be understood that the joint image of this “CP0001” is obtained by superimposing three layers of which layer IDs 403 are “L001,” “L002,” and “L003,” and which are drawn by the users of which user IDs 404 are “U0293441,” “U0009201,” and “U0013890,” respectively.

An example of the data structure of the joint image information 141 is as described above. The presence of the joint image information 141 allows management of the joint image generation and can be used to issue certification information.

### Operation

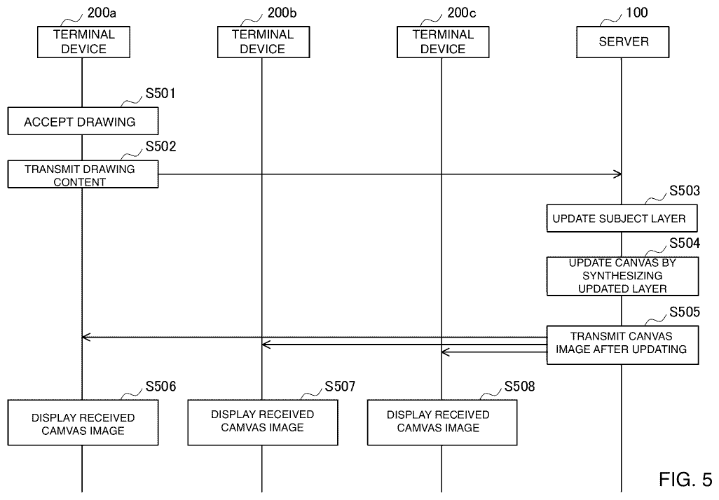

FIG. 5 shows a sequence diagram illustrating an example of exchanges among devices related to a generation process of a joint image in the joint image generating system 1. The sequence diagram shown in FIG. 5 illustrates the exchanges among the devices related to the reflection on the joint image when drawing is performed by a user of a certain terminal device. Here, a case of drawing by the user A of the terminal device 200a will be described as an example. Further, it is assumed that the creation of the joint image is performed by the user B of the terminal device 200b and the user C of the terminal device 200c.

As shown in FIG. 5, the terminal device 200a accepts drawing from the user (step S501). The terminal device 200a then transmits information indicating the content of the drawing to the server 100 (step S502).

If the server 100 receives the information indicating the content of the drawing from the terminal device 200a, it updates the layer associated with the user A of the terminal device 200a by reflecting, on the layer, the drawing on the basis of the information indicating the content of the drawing (step S503). The server 100 updates the canvas and generates a joint image by superimposing and synthesizing the updated layer with other layers, i.e., the layer associated with the user B of the terminal device 200b and the layer associated with the user C of the terminal device 200c (step S504). The server 100 then transmits the generated canvas image (joint image) to the terminal devices, i.e., terminal devices 200a, 200b, and 200c (step S505).

If the terminal device 200a receives the canvas image (joint image) from the server 100, it displays the received canvas image (step S506). In the same manner, the terminal devices 200b and 200c also display the received canvas image (steps S507 and S508). This reflects the drawing performed via the terminal device 200a on all the terminal devices 200.

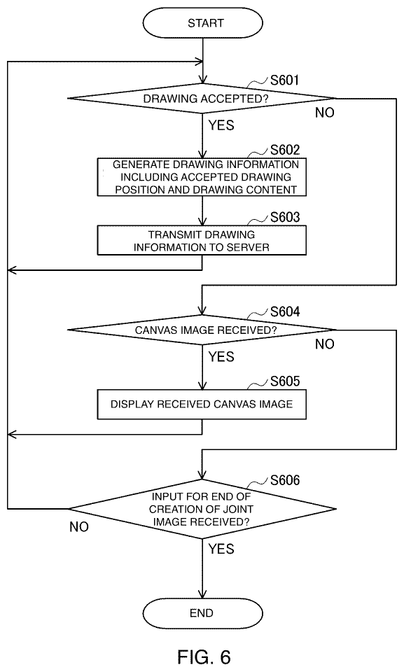

FIG. 6 shows a flowchart illustrating an example of an operation of the terminal device 200 to achieve the exchanges shown in FIG. 5.

As shown in FIG. 6, the controller 230 of the terminal device 200 determines whether drawing to the canvas from the user is accepted via the input unit 220 (step S601). The drawing is performed on the displayed canvas (joint image) at the desired position of the user using a pen tablet, touch panel, and/or mouse, for example, with the type of pen, line width, and colors to be used for the drawing specified. If the drawing is accepted (YES in step S601), the input unit 220 communicates the accepted drawing position to the controller 230.

The controller 230 generates drawing information that includes the accepted drawing position and the content of drawing, i.e., setting information such as the set pen type, line width, and color used (step S602). The controller 230 transmits the generated drawing information to the server 100 via the communication unit 210 (step S603) and returns to the process in step S601.

If the drawing is not accepted (NO in step S601), the controller 230 determines whether a canvas image (joint image) is received from the server 100 via the communication unit 210 (step S604). If the canvas image (joint image) has been received from the server 100 (YES in step S604), the controller 230 causes the output unit 250 to display the received canvas image (step S605). This allows the terminal device 200 to reflect both the drawing performed on its own device and the drawing performed on other terminal devices.

If the canvas image (joint image) has not been received (NO in step S604), the controller 230 determines whether the input for the end of the creation of the joint image is accepted via the input unit 220 or via the communication unit 210 (step S606). The input for the end of the creation of the joint image may be performed by the user of the terminal device 200 via the input unit 220, or may be instructed by the server 100 via the communication unit 210. If the input for the end of the creation of the joint image has not been accepted (NO in step S606), the process returns to the process in step S601, and if it has been accepted (YES in step S606), the process is terminated.

An example of the operation of the terminal device 200 at the time of generating the joint image is as described above.

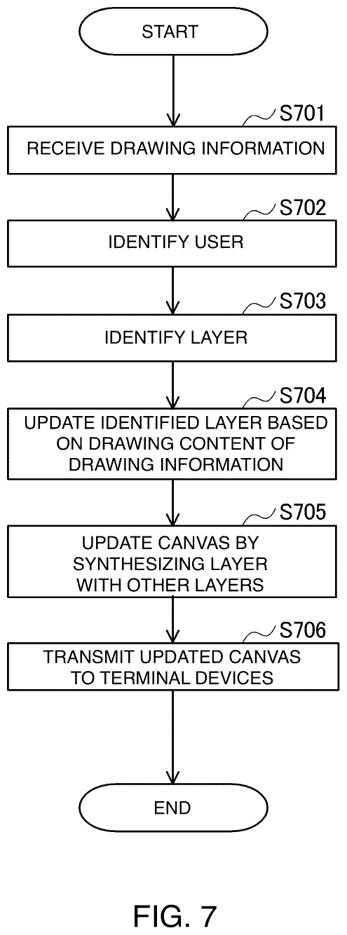

FIG. 7 shows a flowchart illustrating an example of an operation of the server 100 to achieve the exchanges shown in FIG. 5. The flowchart shown in FIG. 7 illustrates the processing of the server 100 to reflect, when drawing is accepted from any of the terminal devices 200 that create the joint image, the drawing on the joint image as well as to update the display content in each of the terminal devices 200.

As shown in FIG. 7, the communication unit 110 of the server 100 receives the drawing information transmitted from any of the terminal devices 200 participating in the creation of the joint image (step S701). As described above, the drawing information may include information such as the position on the canvas (on the layer) where the drawing has been performed, the type, thickness, and color of the pen used, and the user ID of the user that has performed the drawing. The communication unit 110 communicates the received drawing information to the controller 130.

The receiver 131 of the controller 130 accepts the drawing information communicated via the communication unit 110. The receiver 131 communicates the accepted drawing information to the generator 132.

The generator 132 identifies who is the user performing the drawing from the user ID included in the drawing information (step S702).

The generator 132 then identifies the layer associated with the identified user (step S703).

After identifying the layer, the generator 132 updates the layer by reflecting the drawing content indicated in the drawing information on the identified layer (step S704). That is, the generator 132 performs the drawing on the identified layer with the specified pen, thickness, and color at the drawing position indicated by the drawing content.

After updating the layer, the generator 132 superimposes the layer on the layers associated with the other users participating in the creation of the joint image, synthesizes them, and updates the canvas (step S705). The generator 132 then transmits the updated canvas (joint image) to each of the terminal devices 200 of all the users participating in the creation of the joint image via the communication unit 110 (step S706).

This is the process performed by the server 100 for each drawing. In step S701, when drawings from multiple users are accepted simultaneously, the server 100 may be configured such that the layers corresponding to the users are updated, and the canvas is updated simultaneously by synthesizing the multiple layers that have been updated with the layers of the users that have not performed drawing.

As described above, in the joint image generating system 1, the server 100 provides layers for drawing to the users participating in the creation of the joint image, reflects the drawing from each terminal device for the corresponding layer on the joint image, and provides each terminal device 200 with the joint image, thereby providing an environment for multiple users to create an image (joint image).

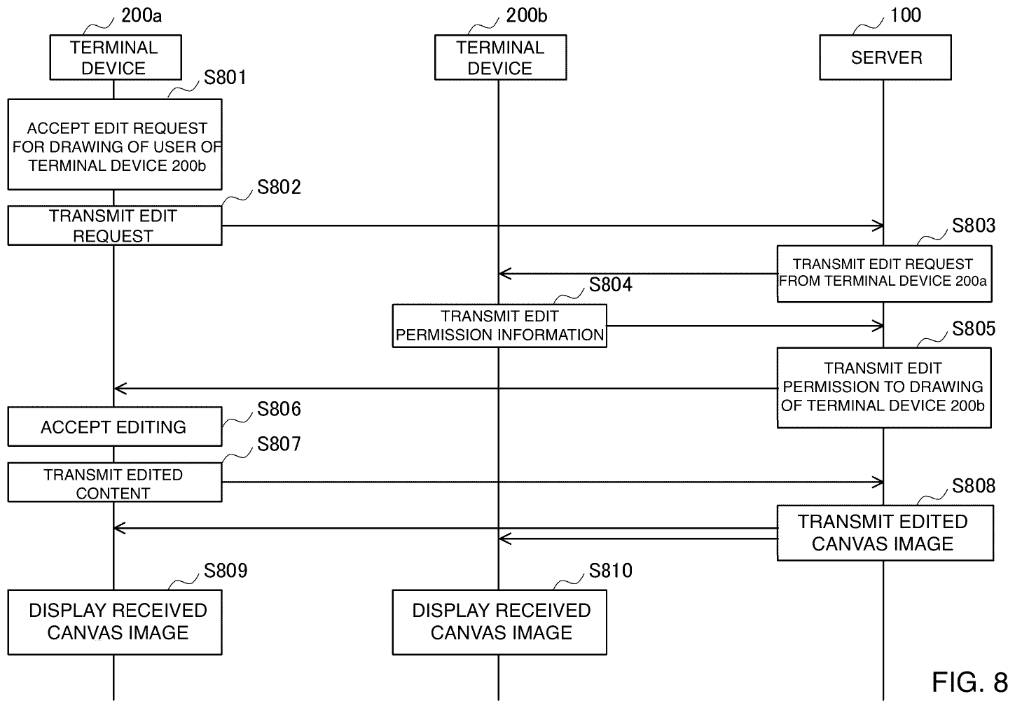

FIG. 8 shows a sequence diagram illustrating an example of exchanges among the terminal devices 200 and the server 100 for editing on the drawing of the other users in the joint image generating system 1. In FIGS. 8 through 11, for the sake of clarity, the case in which the user A of the terminal device 200a requests editing of the drawing performed by the user B of the terminal device 200b will be described.

As shown in FIG. 8, the terminal device 200a accepts an edit request from the user A for the drawing (image that the user B is drawing) performed by the user B of the terminal device 200b (step S802). The terminal device 200a then transmits the edit request to the server 100 requesting editing of the drawing of the user B by the user A (step S802).

When the server 100 receives the edit request from the terminal device 200a, it transmits the edit request from the user A to the terminal device 200b of the user B, which is the target of the edit (step S803).

If the terminal device 200b receives the edit request from the server 100, it displays information indicating that it has accepted the request for editing from the user A and causes the user B to be aware of it. Here, the user B shall allow editing. The terminal device 200b accepts input from the user B indicating permission to edit and transmits the edit permission information to the server 100 (step S804).

Upon receiving the edit permission information from the terminal device 200b, the server 100 transmits to the terminal device 200a the edit permission for the drawing by the user B of the terminal device 200b (step S805).

Upon receiving the edit permission from the server 100, the terminal device 200a accepts input from the user A of the terminal device 200a for the content of editing (drawing content) for the drawing of the user B (step S806). The terminal device 200a then transmits the accepted drawing content to the server 100 as edited content.

The server 100 reflects the edits from the terminal device 200a performed on the drawing content by the user B. The edited canvas image is then generated and transmitted to each of the terminal devices 200a and 200b (step S808).

If the terminal device 200a receives the edited canvas image (joint image) from the server 100, it displays the received canvas image (steps S809 and S810).

Such exchanges allow the joint image generating system 1 to edit the drawings of the other users.

Although not shown in FIG. 8, other terminal devices 200 such as the terminal device 200c may also be included, in which case the edited image of the drawing content of the user B performed by the user A of the terminal device 200a is also transmitted to and displayed on the other terminal device 200c to allow the other user C to also know the content of editing.

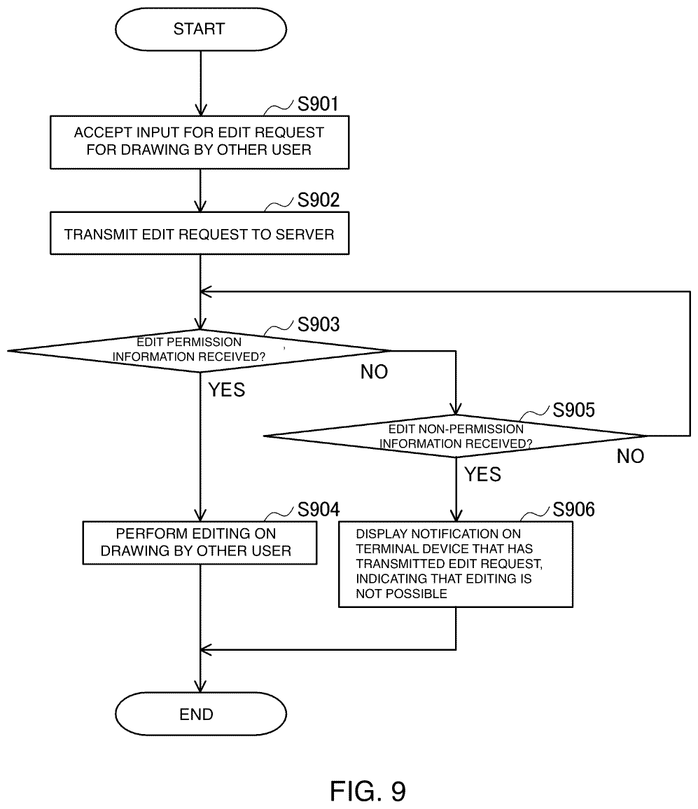

FIG. 9 shows a flowchart illustrating an example of the operation of the terminal device 200, the one requesting editing, to embody the exchanges shown in FIG. 8. This operation will be described as the operation of the terminal device 200a.

The input unit 220 of the terminal device 200a accepts input for an edit request from the user A of the terminal device 200a to request editing of the drawing by a specific other user (step S901). The input unit 220 communicates the accepted input content to the controller 230.

If the controller 230 is communicated the edit request from the input unit 220, it transmits the edit request to the server 100 via the communication unit 210 requesting editing by the user A on the drawing of the other user (step S902). This edit request includes information on the user ID of the user A as the subject of the edit, and the user ID indicating the user that has performed drawing that the user A wishes to edit.

The controller 230 determines whether it has received the edit permission information from the server 100 via the communication unit 210 (step S903). If the controller 230 determines that it has received the edit permission information (YES in step S903), it means that permission has been given by the server 100 to the drawing of the other user, and thus the user A performs edits to the drawing of the specific other user (step S904). The editing itself is the same as the normal drawing, and thus a detailed description thereof is omitted.

In contrast, if the controller 230 determines that it has not received the edit permission information from the server 100 (NO in step S903), it determines whether it has received the edit non-permission information from the server 100 via the communication unit 210 (step S905). If the edit non-permission information has been received (NO in step S905), the process returns to the process in step S903. That is, after transmitting the edit request to the server 100, the controller 230 waits until it receives either the edit permission information or the edit non-permission information.

If the edit non-permission information has been received (YES in step S905), the controller 230 outputs to the output unit 250 a notification indicating that the user A cannot edit the drawing of the specific other user that the user A has requested editing (step S906). The output unit 250 executes the notification by, for example, displaying display information indicating that the editing is not possible on a monitor connected to the terminal device 200a, or by outputting audio information indicating that the editing is not possible on a speaker connected to the terminal device 200a.

An example of the operation when the drawing of another user is edited by the terminal device 200a is as described above.

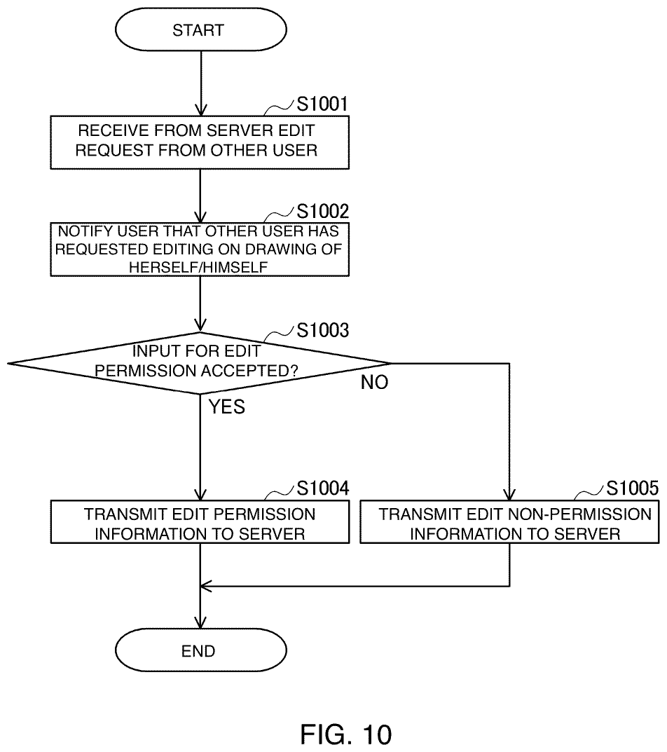

FIG. 10 shows a flowchart illustrating an example of the operation of the terminal device 200, the one that has been requested for editing to embody the exchanges shown in FIG. 8. This operation will be described as the operation of the terminal device 200b.

As shown in FIG. 10, the communication unit 210 of the terminal device 200b receives an edit request from the server 100 indicating that the editing is requested by another user (step S1001). The communication unit 210 communicates the received edit request to the controller 230.

The controller 230 notifies the user that another user is requesting edtiting for the drawing performed by the user B of the terminal device 200b (step S1002). That is, the controller 230 causes the output unit 250 to output information to the user B, indicating that a specific user (in this case, the user A) wishes to modify the content of drawing of the user B. The output may be in any form such as display of text or image, or output of audio. This allows the user B of the terminal device 200b to recognize that the user A of the terminal device 200a wishes to edit the drawing of the user B herself/himself.

The user B of the terminal device 200b checks the notification and determines whether to allow the user A to edit.

The controller 230 determines whether an input for edit permission is accepted from the user B via the input unit 220 (step S1003). If the input for edit permission is accepted (YES in step S1003), the controller 230 transmits the edit permission information indicating that editing by the user A is permitted to the server 100 via the communication unit 210 (step S1004) and terminates the process. In contrast, if the input indicating that the editing is not permitted is accepted (NO in step S1003), the controller 230 transmits the edit non-permission information indicating that editing by the user A is not permitted to the server 100 via the communication unit 210 (step S1005) and terminates the process. An example of the operation of the terminal device 200b is as described above.

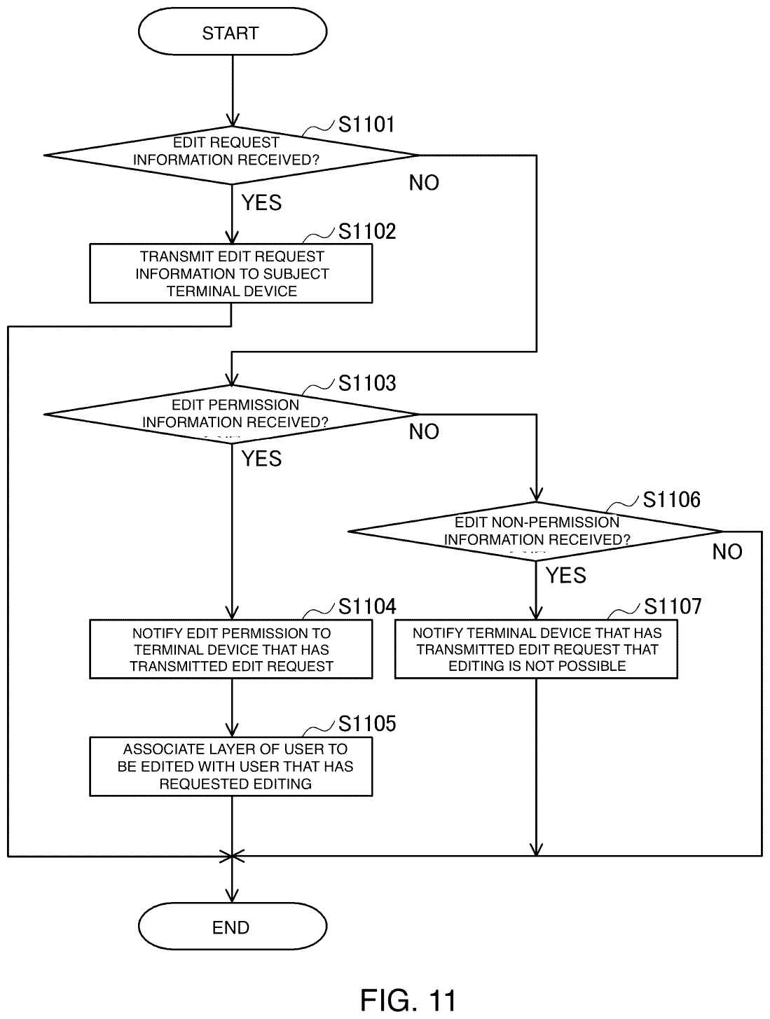

FIG. 11 shows a flowchart illustrating an example of an operation of the server 100 to achieve the exchanges shown in FIG. 8.

As shown in FIG. 11, the communication unit 110 of the server 100 receives a signal from any of the terminal devices 200 and communicates it to the controller 130. The controller 130 determines whether the edit request information has been received via the communication unit 110 (step S1101). The edit request information corresponds to information indicating a request from one specific user participating in the creation of a joint image to edit the drawing of another specific user participating in the creation of the same joint image in the joint image generating system 1.

If the edit request information has been received (YES in step S1101), the controller 130 transmits the edit request information to the terminal device 200 of the user B as the target of the editing indicated by the edit request information, indicating that the user A of the terminal device 200 that has requested for editing is requesting permission to edit the drawing of the user B (step S1102) and the process is terminated.

If the edit request information has not been received (NO in step S1101), the controller 130 determines whether the received signal corresponds to the edit permission information from the terminal device 200b indicating that the user A is allowed to edit the drawing of the user B (step S1103). If the edit permission information has been received (YES in step S1103), the controller 130 notifies the terminal device that has transmitted the edit request of the edit permission (step S1104). That is, the controller 130 transmits edit permission information indicating that the user A is permitted to edit the drawing performed by the user B from the user B that is the target of editing via the communication unit 110 to the terminal device 200a that has transmitted the edit request information.

The controller 130 then cancels the association of the layer that has been associated with the user B, and associates the layer that has been associated with the user B with the user A (step S1105). This allows the user A to edit the drawing performed by the user B. After the user A has edited the image, the association of the layer may be restored.

If the edit permission information has not been received (NO in step S1103), the controller 130 determines whether the edit non-permission information has been received (step S1106). If the edit non-permission information has not been received (NO in step S1106), the process is terminated. If the edit non-permission information has been received (YES in step S1106), the edit non-permission is notified to the user A that has requested the edit, indicating that the user B has not allowed editing. That is, the controller 130 transmits to the terminal device 200a of the user A, via the communication unit 110, the edit non-permission information indicating that editing of the drawing of the user B cannot be permitted (step S1107), and terminates the process.

The process when the first user (user A in the above description) wishes to edit the drawing of the second user (user B in the above description) is as described above.

Finally, the process of issuing certification information that proves that a portion of the joint image has been drawn by a specific user in the joint image generating system 1 will be described. Although the copyright of the resulting joint image may be ambiguous due to the joint image creation process, the joint image generating system 1 assigns layers to corresponding users, guaranteeing that the content drawn by each user belongs to the corresponding user. When such proof of the copyright or other necessary information is required, the server 100 issues the certification information to the user (terminal device).

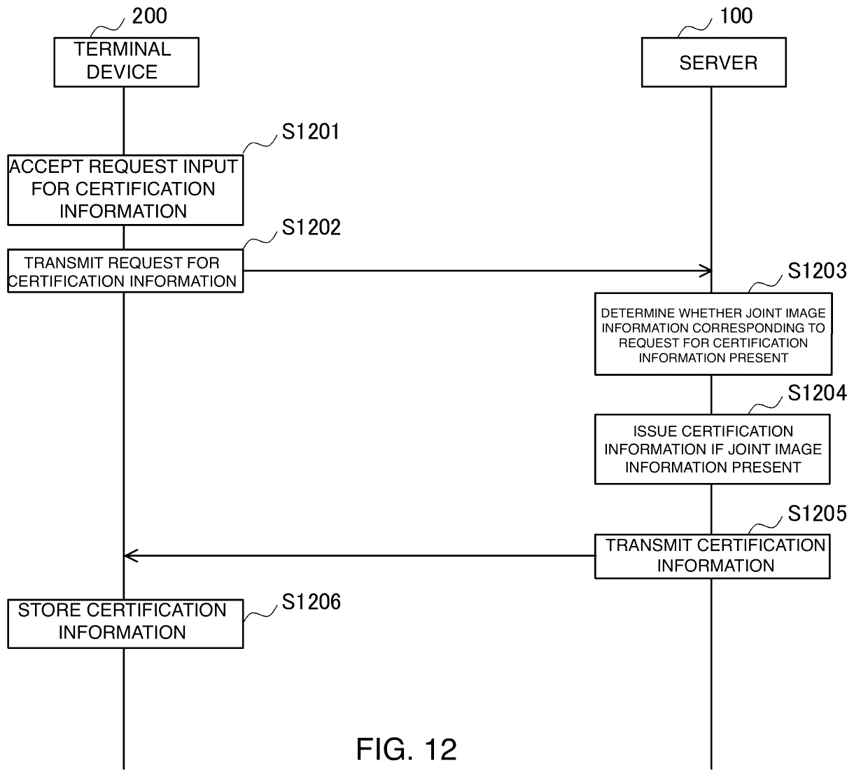

FIG. 12 shows a sequence diagram illustrating an example of exchanges among the devices for editing on the drawing of the other users in the joint image generating system 1.

As shown in FIG. 12, the terminal device 200 accepts a request input for certification information from a user (step S1201). The terminal device 200 then transmits the request for certification information to the server 100 (step S1202). Here, the request for certification information includes information that can identify the image drawn by the user of the terminal device 200. As an example, the request for certification information may include the date and time the joint image has been created, information on the joint image ID that identifies the joint image created, and a user ID indicating the user of the terminal device 200.

If the server 100 receives a request for certification information from the terminal device 200, it determines whether joint image information corresponding to the request for certification information is present (step S1203). If the joint image information is present, the server 100 issues certification information (step S1204). The server 100 transmits the issued certification information to the terminal device 200 (step S1205).

If the terminal device 200 receives the certification information from the server 100, it stores the certification information (step S1206) and terminates the process. This allows the terminal device 200 to present information that proves what image the user has drawn and that it has been indeed drawn by the user of the terminal device 200.

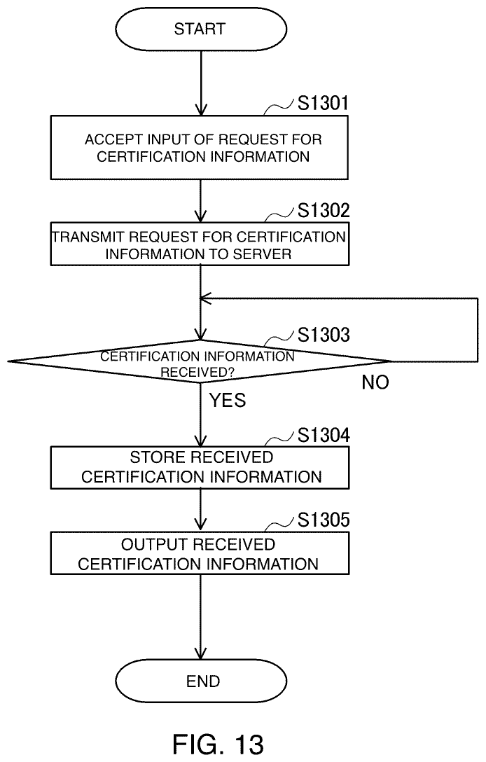

FIG. 13 shows a flowchart illustrating an example of an operation of the terminal device 200 to achieve the exchanges shown in FIG. 12.

As shown in FIG. 13, the input unit 220 of the terminal device 200 accepts input from the user for a request for certification information (step S1301) and communicates it to the controller 230. Such input includes the input of information that can identify which image is for the certification information, for example, it may be a joint image ID that identifies the joint image.

The controller 230 generates a request for certification information, which includes the user ID of the user of the terminal device 200 and at least one of the joint image ID or, alternatively, the date and time of creation of the joint image. The controller 230 then transmits the generated request for certification information to the server 100 via the communication unit 210 (step S1302).

The controller 230 determines whether the certification information has been received from the server 100 via the communication unit 210 (step S1303). The controller 230 waits until the certification information is received from the server 100 (NO in step S1303). If the certification information has been received (YES in step S1303), the controller 230 stores the received certification information in the storage 240 (step S1304). The controller 230 then causes the output unit 250 to output the certification information (step S1305) and terminates the process. The output of the certification information may be the display of an image showing the certification information and may be performed at any time.

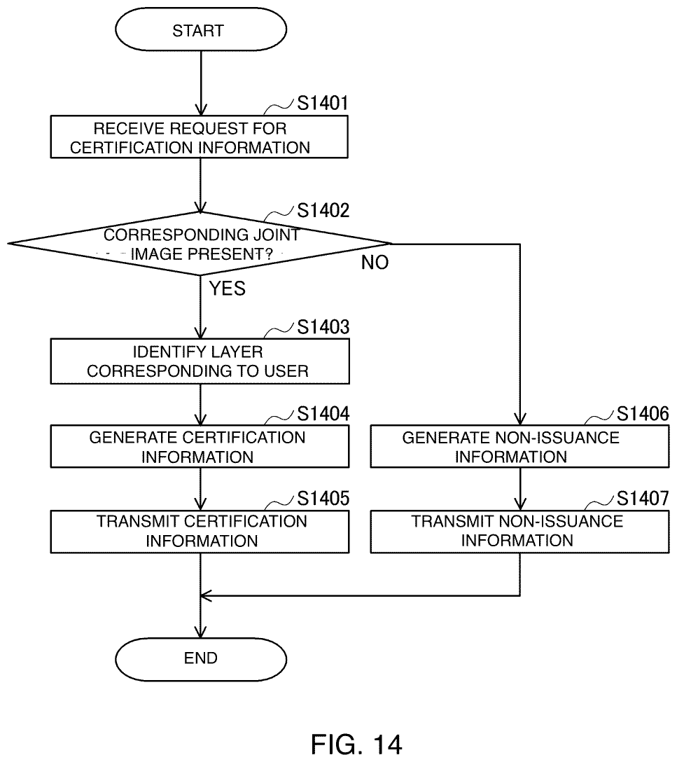

FIG. 14 shows a flowchart illustrating an example of an operation of the server 100 to achieve the exchanges shown in FIG. 12.

As shown in FIG. 14, the communication unit 110 of the server 100 receives a request for certification information from the terminal device 200 (step S1401). The request for certification information from the terminal device 200 includes information on the user of the terminal device 200 (user ID) and information indicating what date and time of the image the user is requesting the certification information for (joint image ID or date and time information). The communication unit 110 communicates the received request for certification information to the controller 130.

The controller 130 determines whether a corresponding joint image is present on the basis of the communicated request for certification information (step S1402). That is, if a joint image ID is included in the request for certification information, the controller 130 determines whether a joint image indicated by the joint image ID is present by referring to the joint image ID 401 in the joint image information 141. If the joint image ID is not included in the request for certification information but the user ID and date and time information are included in it, the controller 130 refers to the date and time information 402 of the joint image information 141 and the user ID 404 to perform determination.

If a corresponding joint image is present (YES in step S1402), the controller 130 identifies the layer associated with the user ID associated with the identified joint image by checking the layer ID 403 (step S1403).

Then, referring to the layer image corresponding to the identified layer ID and the corresponding date and time information 402, the controller 130 generates certification information including the identification information of the user (name), date and time information indicating when it has been drawn, and an image indicating what has been drawn (step S1404).

The controller 130 transmits the generated certification information to the terminal device 200 that has requested the certification information via the communication unit 110 (step S1405) and terminates the process.

If a joint image of the certification information requested in the request for certification information is not present (NO in step S1402), the controller 130 generates non-issuance information indicating that the certification information cannot be issued due to lack of corresponding information (step S1406). The controller 130 then transmits the generated non-issuance information via the communication unit 110 to the terminal device 200 that has requested the certification information (step S1407) and terminates the process.

The operation for the process of issuing certification information is as described above.

### Specific Examples

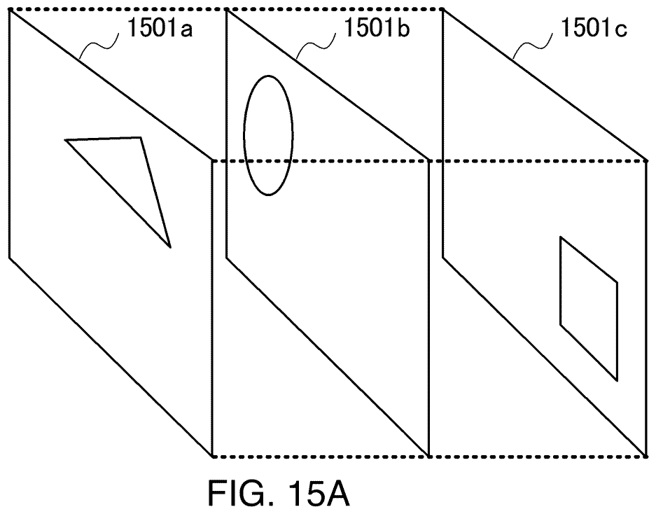

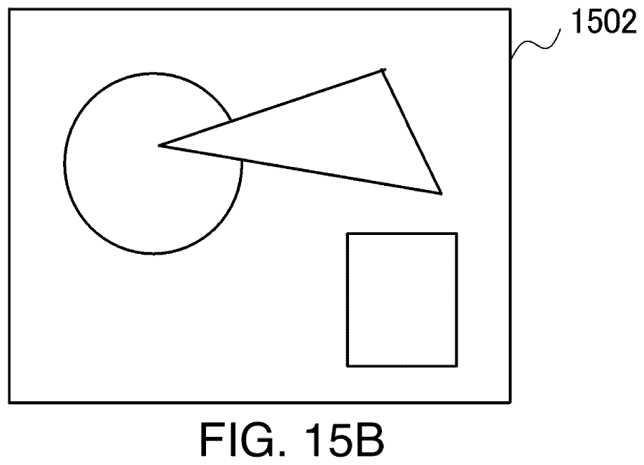

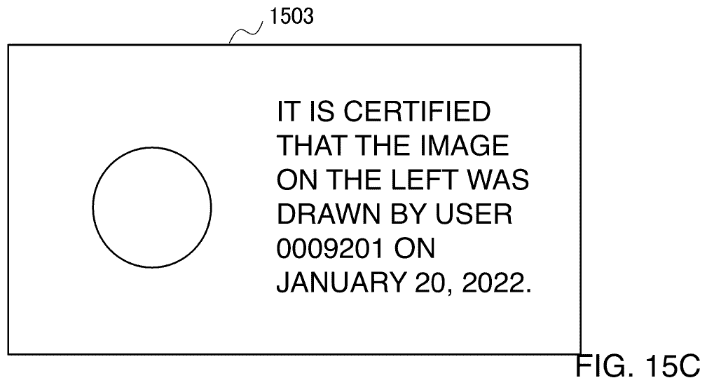

With reference to FIGS. 15A to 15C, examples of images of layered images, joint images, and certification information will be described.

FIG. 15A shows an example of a composition of the joint image. As mentioned above, and as shown in FIG. 15A, the joint image corresponds to a superimposed composite of the layered images assigned to the users each. Basically, one layer is assigned to each user, and each user essentially draws on the layer assigned to her or him, but a common joint image is displayed on each of the terminal devices 200a to 200c. FIG. 15A shows an example where a layer image 1501a, layer image 1501b, and layer image 1501c are superimposed in this order, resulting in a joint image 1502 shown in FIG. 15B.

FIG. 15B shows an example of a joint image obtained by superimposing and combining the layer images shown in FIG. 15A. When the layer images are superimposed in the order shown in FIG. 15A, the joint image is displayed as shown in FIG. 15B. Whether the content drawn by each user is displayed on the front side is determined in accordance with the order of overlap of the layers. In the example in FIG. 15A, the layer image 1501a is on a higher layer (higher priority) than the layer image 1501b, and thus the picture drawn in the layer image 1501a has priority (front side) over the picture drawn in the layer image 1501b to be displayed as shown in FIG. 15B. This priority may be optional, and the joint image generating system 1 may be configured so that the priority can be determined and set among users that create a joint image, or the system 1 may simply assign a higher priority in the order of participation in the creation of the joint image.

FIG. 15C shows a drawing illustrating an example of certification information. As shown in FIG. 15C, the certification information 1503 may be any information that certifies who has drawn, what has been drawn, and when the drawing has been performed, and may also include other information such as the joint image drawn at that time and details of the user that has drawn it.

### SUMMARY

As shown above, the server 100 for the joint image generating system 1 can accept drawing from each user and provide each user with a joint image on the basis of what each user has drawn as if all the users perform drawing on the same canvas. The server 100 can then associate and store the drawing from each user with her/his corresponding layer, thereby identifying which user has drawn which content and providing certification information certifying the same.

### Variations

Although one aspect of this disclosure is described in the embodiments above, the ideas of this disclosure are not limited to this. Various variations included as the ideas of this disclosure will be described below.

(1) In the embodiment above, for the sake of clarity of content, an example is shown of image generation by multiple users at respective terminal devices 200 by transmitting a joint image in which layers corresponding to the respective users are combined to each of the terminal devices 200 on the basis of the drawing from each of the terminal devices 200. However, if the server 100 is configured to sequentially generate a joint image by compositing layers updated with the content of the drawing on the layer corresponding to each user and transmit it to each terminal device 200, real-time performance may be lacking. That is, delays may occur due to the compositing process at the server 100 as well as delays due to communication delays associated with the transmission of the joint image itself. This may cause, at each of the terminal devices 200, a divergence between the actual joint image and the joint image displayed by each of the terminal devices 200.

Accordingly, when the server 100 receives drawing from each user, it may transmit the information indicating the content of the drawing received from each user as it is to the terminal device 200 of each of the other users as information on the joint image, and generate and display the joint image in accordance with the information indicating the content of the drawing received at each terminal device 200. In the terminal device 200 where the drawing has been performed, the terminal device 200 may be configured to directly generate and display a joint image at the stage of accepting the drawing from the user.

Accordingly, the information exchanged between each terminal device 200 and the server 100, i.e., the information indicating the content of the drawing requires less amount of information to be exchanged than the joint image itself so that the communication time may be reduced in comparison to a case of exchanging the joint image itself, thereby in turn reducing the delay. Also as for the generation of a joint image, when the joint image is generated on the terminal device 200 side, it can be configured so that only the drawing of the position indicated by the information on the joint image needs to be updated, thereby simplifying the processing time and reducing the load on the device while also reducing the processing time.

(2) In the embodiment above, an example is shown in which each user performs drawing while viewing the joint image, but it is not limited to this. In each terminal device 200, it may be configured to switch between displaying a joint image and a layer image by input from the user. This configuration allows the user to perform drawing without worrying about drawing of the other users by switching to the display of her/his own layer image when drawings of the other users overlap with her/his own drawing, resulting in her/his own drawing being invisible.

The joint image and the layer image may be displayed simultaneously on the terminal device 200. That is, the joint image and the layer image may be displayed in parallel, and the user may perform drawing on both the joint image and the layer image that are displayed. The drawing on the joint image and the layer image will in both cases be performed on the layer image that is associated with the user. This configuration allows the user to perform drawing while comparing the joint image with what she or he has substantially drawn.

(3) Although not specifically mentioned in the embodiment above, the joint image generating system 1 may further provide a communication system for exchanges between users involved in creating the joint image. That is, the server 100 may function as a server that relays the exchange of messages among the users, and the exchange of messages may be through a chat system using strings of text, or it may be a voice exchange. This allows the users to evaluate the pictures with each other, suggest improvements, or perform other requests in real time.

(4) In the embodiment above, an example is described in which the user A modifies the content drawn by the user B. At this time, the server 100 is configured to allow the layer that has been associated with the user B to be associated with the user A, thereby enabling the user A to modify the drawing content of the user B. At this time, the server 100 may have a registration function that additionally registers the user A as a user corresponding to the layer that has been associated with the user B in the joint image information 141. One layer may be shared by multiple users from the beginning, depending on the settings for the server 100 of the joint image generating system 1. In this case, information in which two or more users are associated with one layer is stored in the joint image information 141. When multiple users are associated with one layer, information on drawing content of each user may be retained, identifying which portions of the one layer are drawn by which users and which other portions are drawn by which other users. This manages who and on which layer the drawing has been performed when multiple users have performed drawing on the one layer.

(5) In the embodiment above, a layer is assigned to each user. However, in addition to the layers associated with the corresponding users, a free layer on which anyone can perform drawing may be provided. The free layer corresponds to a layer on which anyone is allowed to perform drawing, and the users corresponding to the free layer may be all users that have participated in the creation of the joint image, or all users that actually have performed drawing on the free layer. As for the drawing on the free layer, basically, a user that wishes to perform drawing on the free layer at any given time applies to the server 100 for the right to use the free layer, and drawing is permitted if no other users are drawing on the free layer at that time. The user that has been drawing on the free layer can apply to the server 100 to release the free layer when she/he finishes drawing, so that no one is drawing on the free layer. This allows the server 100 to provide additional convenience to users in creating a joint image.

(6) In the embodiment above, each user creates a joint image in real time, but this does not have to be simultaneous in real time. That is, the timing for creating a joint image need not be the same for all users at the same time. For example, the user A may perform drawing on the joint image from 12:00 to 13:00, and the user B may perform drawing on the same joint image from 20:00 to 22:00. In such a case, a joint image may be created by each user specifying at the start of drawing which joint image (e.g., joint image ID) she/he will participate in creating. This allows the users to cooperate to create an image even if their timing does not coincide with each other.

(7) In the embodiment above, the server 100 may retain a layer combining function that combines multiple layers. For example, the layer A of the user A and the layer B of the user B may be superimposed and combined into a single layer. In this case, as for combining the layers, when requests for combining the layers from both the terminal device 200a of the user A and the terminal device 200b of the user B are performed, the server 100 may combine the layers that are associated with both the users and specified. In the combining of the layers, which layer is the top (front side) may be determined by the users, and the layers may be combined in the determined order. When drawing is performed on the same coordinate position between the layers, the color of the respective drawing contents may be superimposed in the form of a composite (intermediate color). This also allows the joint image generating system according to the present embodiment to execute layer combining function provided in general drawing software to perform drawing without any discrepancy with existing drawing software. The combining of the layers may be combining of the layers between different users or layers assigned to the same user.

(8) In the embodiment above, an example of issuing certification information to one person is shown, but this certification information may be issued to multiple users. That is, if multiple users involved in the layer for the certification information are present, multiple user names may be listed for the certification information to be issued. That is, for the user name recited in the certification information in FIG. 15C, the identifying information (name) of each of the multiple users corresponding to the layer is recited. This ensures that even if multiple users are associated with one layer, at least the content drawn to that layer has been executed by those multiple users.

(9) In the above embodiment, the functional units of the server 100 may be embodied by logic circuits (hardware) or dedicated circuits formed in integrated circuits (IC) chips and large scale integration (LSI), for example, or by software using central processing unit (CPU) and memory. Each functional unit may be embodied by one or more integrated circuits, and the functions of multiple functional units may be embodied by a single integrated circuit. LSIs are sometimes called VLSIs, Super LSIs, and Ultra LSIs, for example, depending on the level of integration. The term “circuit” may include the meaning of digital processing by a computer, i.e., as a functional process by software. The circuit may also be embodied by a reconfigurable circuit (e.g., field programmable gate array FPGA).

When each functional unit of the server 100 is embodied by software, the server 100 includes a CPU that executes the instructions of the input program as software that embodies each function, a read only memory (ROM) or storage (referred to as “recording media”) in which the input program above and various data are readably recorded by a computer (or CPU), and a random access memory (RAM) that develops the input program above, for example. The object of this disclosure is achieved by a computer (or CPU) reading and executing the above input programs from the above recording media. As the recording media above, “non-transient tangible media” such as tapes, disks, cards, semiconductor memory, and programmable logic circuits may be used. The input program above may be supplied to the computer above via any transmission medium (e.g., communication network, and broadcast wave) capable of transmitting the input program. The invention can also be embodied in the form of a data signal embedded in a carrier wave, in which the input program above is embodied by electronic transmission.

The input program above can be implemented using, for example, scripting languages such as ActionScript and JavaScript (registered trademark), object-oriented programming languages such as Objective-C and Java (registered trademark), and markup languages such as HTML5, but, it is not limited to these.

(10) The various configurations and forms illustrated in the embodiments as described above may be combined as appropriate.

What is claimed is:

1. A joint image generating device comprising:
an output unit that outputs information on a canvas that accepts drawing from a user;
a receiver that accepts drawing on the canvas from each of a plurality of users;
a generator that generates an image by reflecting the drawing from each of the users on the canvas; and
a storage that associates and stores an image drawn on the canvas with user identification information that indicates the user that has performed drawing on the image, wherein
the output unit outputs the image generated by the generator.

2. The joint image generating device according to claim 1, wherein
the receiver accepts drawing on a layer as a canvas that can be drawn by each user for each of the users,
the storage stores a layer identifier that identifies the layer on which corresponding users have performed drawing, and
the generator superimposes the layer of each of the users to reflect the drawing from each of the users on the canvas to create the image.

3. The joint image generating device according to claim 2, further comprising:
a first request receiver that accepts an edit request from a first user of the users for an image input by a second user other than the first user;
a first transmitter that transmits the edit request from the first user to the second user;
a receiver that receives permission/rejection information indicating permission/rejection of editing by the first user from the second user; and
an editing unit that accepts drawing by the first user on the image that has been drawn by the second user and edits the image that has been drawn by the second user if the permission/rejection information indicates permission.

4. The joint image generating device according to claim 3, wherein the editing unit accepts drawing from the first user and edits the layer indicated by the layer identifier associated with the second user on the basis of the accepted drawing from the first user.

5. The joint image generating device according to claim 3, further comprising:
a second transmitter that transmits to the first user rejection information indicating that drawing cannot be performed by the first user on the image that has been drawn by the second user when the permission/rejection information indicates rejection.

6. The joint image generating device according to claim 2, further comprising:
a specifier that accepts from each of the users specification of a layer to be drawn by the user, wherein
the storage associates and stores a layer identifier indicated by the specification of the layer from the user accepted by the specifier with a user identifier of the user that has specified the layer.

7. The joint image generating device according to claim 1, further comprising:
a second request receiver that accepts a request from a third user of the users to output the image drawn by the third user for the image drawn on the canvas; and
a third transmitter that transmits to the third user an image of a portion drawn by the third user and certification information that certifies that the image has been drawn by the third user when the output request is accepted.

8. A joint image generating method causing a computer to execute the steps of:
outputting information on a canvas that accepts drawing from a user;
accepting drawing on the canvas from each of a plurality of users;
generating an image by reflecting the drawing from each of the users on the canvas; and
associating and storing an image drawn on the canvas with user identification information that indicates the user that has performed drawing on the image, wherein
the outputting step outputs the image generated in the generating step.

9. A non-transitory computer readable medium storing therein a joint image generating program causing a computer to embody the functions of:
outputting information on a canvas that accepts drawing from a user;
accepting drawing on the canvas from each of a plurality of users;
generating an image by reflecting the drawing from each of the users on the canvas; and
associating and storing an image drawn on the canvas with user identification information that indicates the user that has performed drawing on the image, wherein
the outputting function outputs the image generated by the generating function.
